(19) United States
(12) Patent Application Publication
(10) Pub. No.: US 2007/0224358 A1
(43) Pub. Date: Sep. 27, 2007

(54) AIRLESS SPRAY-COATING OF A SURFACE WITH AN AQUEOUS ARCHITECTURAL COATING COMPOSITION

(76) Inventors: Saturnino Insausti-Eciolaza, Tolosa-Guipuzcoa (ES); Renos Mouzouras, Castle Carey (GB)

Correspondence Address: THE GLIDDEN COMPANY, 15885 WEST SPRAGUE ROAD, STRONGVILLE, OH, 44136, US

(21) Appl. No.: 11/674,535

(22) Filed: Feb. 13, 2007

Related U.S. Application Data
(63) Continuation-in-part of application No. PCT/EP05/08760, filed on Aug. 10, 2005.

(30) Foreign Application Priority Data
Aug. 13, 2004 (EP) 04380170.3

(51) Int. Cl. B05D 7/00; B05D 1/02; B05C 5/00

(52) U.S. Cl. 427/407.1; 427/421.1; 118/300

(57) ABSTRACT

A process for the airless spray-coating of a surface with a aqueous-containing Newtonian or non-Newtonian architectural coating composition wherein the composition can contain an associative thickener and is subjected to a pressure of from 2 to 5 bar generated such as by a hand-operated or battery operated electrical compressor and then sprayed from a slot-shaped outlet orifice (52) in a nozzle (50) to produce an outflow (31) of composition having boundaries (35) which diverge at least until it has formed a front of at least 30 mm in width. The composition preferably has a Brookfield viscosity of at least 0.5 pa.sec and a solids content of 7 wt %. Also apparatus for performing the process comprising a container containing the coating compositions together with a nozzle having an outlet orifice, a compressor and a pressure release valve actuatable in the pressure range 2 to 5 bar and preferably an auxiliary orifice upstream of the outlet orifice. The process and apparatus enable the viscous compositions to be applied quickly using low pressures easily generated by a hand compressor.

This application is a continuation-in-part (CIP) of copending PCT international application No. PCT/EP 2005/008760 entitled “Airless Spray-Coating of a Surface with a Viscous Aqueous Architectural Coating Composition”, having an International Filing Date of Aug. 10, 2005 and published in the English language as International Publication No. WO 2006/015869 which designated the United States. International application No. PCT/EP 2005/008760 claims the benefit of priority to European Patent Application 04380170.3 filed Aug. 13, 2004.

### FIELD OF THE DISCLOSURE

The present invention relates to a process and an apparatus for the airless spray-coating of a surface with an aqueous containing architectural coating composition. More specifically this disclosure relates to an apparatus and process for the airless spray-coating of a surface with a viscous aqueous architectural coating composition (such as a woodstain, paint, lacquer or varnish) being a process able to cope with both Newtonian and non-Newtonian flows if necessary at pressures of up to 5 bar.

### TECHNICAL CONSIDERATIONS FOR THE DISCLOSURE

Achieving facile spraying performance for the do-it-yourself (“DIY”) user with a low pressure sprayer, for example, from simple hand pumps is complicated by compositions that may have non-Newtonian flow. Also for compositions with Newtonian flow, a sprayer in the hands of a novice can lead to problems in application from a trigger type on and off switch if the composition spits from the sprayer as the trigger is released. The significance of hand pumps (or more correctly “hand-operated compressors”) is that they are suitable for use by DIY users, who usually lack the sophistication, experience, or will of skilled application professionals to invest in the sophisticated types of expensive high pressure spraying apparatus currently used to spray aqueous-containing compositions in industry.

An “airless” spray-coating process is a process which does not require an accompanying stream of air to assist its atomisation during spraying, such a process being known.

U.S. Pat. No. 4,756,481 and WO2004/012800 identify the fact that either a hand pump and/or an electrically powered pump are suitable for pressuring a coating composition to enable it to be sprayed.

WO2004/012800 discusses the limitations of hand and electrically powered airless spray coating apparatus. WO2004/012800 states that the problem with spray apparatus utilising a hand pump is that the pressure achievable is limited by the manual effort required, and is therefore not suitable for spraying certain types of coating compositions. The problem with electrically powered spray apparatus is that the apparatus needs to be connected to a power source, or if batteries are used, frequent changing or recharging is required.

U.S. Pat. No. 4,756,481 states that airless systems do not use pressured air, and that airless systems can utilise an electrically driven pump to transport the coating composition prior to it being sprayed. U.S. Pat. No. 4,756,481 also states that the use of an additional hand compressor to pressurise the air in the chamber above the coating composition places less of a load requirement on the electric pump such that in effect, the hand pump is being used as an auxiliary compressor.

Thus both U.S. Pat. No. 4,756,481 and WO2004/012800 recognise that both hand and electrically powered pumps can be used to spray coating compositions, and that the choice depends on the pressure required, for example, if the pressure required cannot be obtained by hand pumping then an electrically powered pump is necessary.

Architectural coating compositions are designed for application to surfaces found in or as part of buildings such as walls, ceilings, window frames, doors and door frames, radiators and customised furniture. They can also be supplied for application to surfaces related to buildings which surfaces are found in land (eg. gardens and yards) surrounding buildings. Such related surfaces include the stone or concrete surfaces of walls and the planed or rough cut wooden surfaces of fences, gates and sheds. Architectural coatings are intended to be applied on site at ambient temperatures and humidity by either amateur and/or professional painters. Ambient temperatures are typically from 5 to 45° C. Aqueous architectural coating compositions are often called “latex” or “emulsion” paints if they contain significant amounts (eg. more than 7 wt %) of solid materials.

Aqueous architectural coating compositions comprise an organic film-forming binder polymer which firstly serves to bind a dried coat of the composition to a surface to which it has been applied and secondly serves to bind any other ingredients of the composition such as pigments, dyes, opacifiers, extenders and biocides into the dried coat, The binder polymer is a significant cause of non-Newtonian flow.

A wide variety of conventional film-forming binder polymers are available for use in architectural coating compositions, but those most commonly used are of three broad types obtained from mono-ethylenically unsaturated monomers and known colloquially as “acylics”, “vinyls” or “styrenics”. The “acrylics” are usually copolymers of at least two alkyl esters of one or more mono-ethylenically unsaturated carboxylic acids (e.g. methyl methacrylate/butyl acrylate copolymer) whilst the “vinyls” usually comprise copolymers of a mono-vinyl ester of a saturated carboxylic acid such as vinyl acetate and at least one of either an acrylic monomer or a different mono-vinyl ester, often the vinyl ester of a carboxylic acid containing 10 to 12 carbon atoms such as those sold under the trade name “Versatate” by Resolution Europe BV of Rotterdam. The “styrenics” are copolymers containing styrene (or a similar mono-vinyl aromatic monomer) together with a copolymerisable monomer which is usually an acrylic. A fuller description of suitable aqueous binder polymers is given in the third edition of an “Introduction to Paint Chemistry” by G P A Turner, published in 1967 by Chapman and Hall of London, the contents of which are herein incorporated by reference.

Architectural coating compositions need a viscosity at low sheer (ie. a Brookfield viscosity) of at least 0.5 pa.sec (pascal.second) so that if they are applied to a vertical surface, the applied coating will generally resist “sagging”, ie. running down the surface before the coating has had time to dry enough to lose fluidity. “Sagging” is illustrated in Plate 14 of the “Handbook of Painting and Decorating Products” by A H Beckly published in 1983 by Granada of London, the contents of Plate 14 are herein incorporated by reference. In aqueous coating compositions, much of the viscosity is often imparted by the inclusion of celluilosic thickeners of long or medium chain lengths and these too contribute to non-Newtonian flow. A fuller description of thickeners suitable for use in aqueous architectural coating compositions is given by E J Schaller and P R Sperry in Chapter 4 of Volume 2 of “The handbook of Coatings Additives” edited by L J Calbo, the contents of which Chapter 2 are herein incorporated by reference.

Schaller and Sperry explain that there is a need for thickeners in latex paints to adjust viscosity in order to control various properties of the paints including sagging and also film build and levelling. They list the various ways in which viscosity can be increased, but conclude that thickeners (which they alternatively call “water-soluble polymers”) afford a much more efficient and controllable means of adjusting viscosity. Schaller and Sperry continue by distinguishing between two types of thickeners known as “non-associative thickeners” and “associative thickeners”. Non-associative thickeners are water soluble (or at least water-swellable) polymers which increase viscosity mainly by overlap and/or entanglement of their polymer chains and/or by their occupation of large volumes of space within the coating composition. These affects are promoted by the molecular weight, stiffness and straightness of their polymer chains, Associative thickeners are also water-soluble (or at least water-swellable) polymers. They have chemically attached hydrophobic groups that are capable of self-association into micellar-like assemblies as well as non-specific adsorption onto all colloidal surfaces present. This behaviour is similar to that of conventional surfactants. It results in a transient network of polymer chains which increase the Brookfield viscosity of coating compositions.

By far the most important non-associative thickeners are the long, medium or short chain cellulose ethers known as “cellulosics” which comprise straight and stiff polymeric backbones making cellulosics exceptionally effective in increasing the viscosity of aqueous systems. Chain length is defined in terms of weight average molecular weights as derived from viscosity measurements. Examples of cellulosics include hydroxyethyl cellulose, methyl cellulose, hydroxypropylmethyl cellulose and ethylhydroxyethyl cellulose

Long chain (eg. molecular weights above 250 000 Da) and medium chain (eg. 100 000 to 250 000 Da) cellulosics increase viscosity by chain entanglement which enables high Brookfield viscosities to be achieved at low concentrations. However if the concentrations of cellulosics have to be increased to achieve the high shear viscosities needed for high film build, they will also impart unwanted high elasticity to the coating composition contributing to poor atomisation during spraying and a subsequent inhibition of the levelling of the freshly applied coating.

Short chain cellulosics (eg. molecular weights below 100 000 Da) increase viscosity mainly by concentration affects (eg. occupation of volume) and so they are less likely to produce unwanted increases in elasticity. However, higher concentrations are needed to achieve the required Brookfield viscosities. Such high concentrations are expensive to use and they significantly harm the water-resistance of the applied coating when dry.

Associative thickeners overcome the shortcomings of cellulosics. The transient networks they create produce increases in Brookfield viscosity comparable with those achievable with high molecular weight cellulosics. This allows them to be used in relatively small concentrations which do not seriously detract from the water-resistance of the dried coating. Also associative thickeners are relatively low in molecular weight and so they do not form the entanglements which give the unwanted high elasticity which hinders spraying and levelling.

Schaller and Sperry report that four main types of broadly hydrophobicly modified equivalent performances have found extensive commercial use in aqueous coating compositions. The first main type is the hydrophobically modified alkali soluble emulsion or “HASE” type. Commercial examples of HASEs have hydrophilic backbones comprising salts of polymerised or copolymerised unsaturated carboxylic acids or acid anhydrides such as acrylic or methacylic acids or maleic anhydride. Hydrophilic moieties such as polyalkylene glycols (eg. polyethylene glycol) are attached to the hydrophilic backbones and hydrophobic groups are in turn are attached to the hydrophilic moieties. In use, solutions of these HASEs are added as free-flowing liquids to a coating composition at neutral or slightly acidic pH. An increase in Brookfield viscosity is then caused by raising the pH to mildly alkaline conditions whereupon carboxylate anions are formed.

The second type of associative thickener is the hydrophobicly modified hydroxy alkyl (especially ethyl) cellulosic or “HMHEC” type conveniently made by the addition of long chain alkyl epoxides to hydroxyalkyl celluloses of the type used as non-associative thickeners.

The third type of associative thickener is the block/condensation copolymer “HEUR” type comprising hydrophilic blocks and hydrophobic blocks usually terminating in hydrophobic groups. The hydrophilic blocks may be provided by polyalkylene oxide (especially polyethylene oxide) moieties of relatively low molecular weight of say below 10 000 Da, preferably 3 400 to 8 000 Da. The hydrophilic blocks are condensed with for example hydrophobic urethane-forming di-i-isocyanates such as toluene di-isocyanate.

The fourth type of associative thickener is the hydrophobicly modified polyacrylamide type in which the hydrophobic groups are incorporated as free radical copolymers with N-alkyl acrylamides. These are most useful in acidic acidic coating compositions.

A fifth major type of associative thickener has been introduced since Schaller and Sperry's review. This is the hydrophobicly modified ethoxylated oxide urethane alkali-swellable emulsion or “HEURASE” type. This type combines the functionality of the HASE and HEUR types.

Many surfaces, especially the surfaces of rough cut (ie. unplaned) wood, are left uncoated even in circumstances where they would benefit from the decorative or protective results achievable using architectural coatings. It is estimated that in Britain, two thirds of surfaces which could benefit from aqueous coatings are nevertheless left uncoated because coatings by brush or roller is too time consuming. For example when the coating composition is aqueous and viscous, a standard size fence panel of rough cut wood takes about 9 to 10 minutes to coat by brush or 4 to 5 minutes to coat by roller. A professional painter using an electrically powered airless high pressure spraying apparatus operating at pressures of over 50 bar can coat the same panel in 30 to 60 seconds. Unfortunately, few amateur users would want to purchase such electrically powered apparatus nor would they be comfortable using such high pressures.

Inexpensive low pressure spraying apparatus which can be pressurised up to about 3 bar using a hand-operated compressor is widely used by amateurs (especially gardeners) for spraying organic solvent-based liquids such as woodstains, fungicides and insecticides. These compositions are simple to spray because they have negligible Brookfield viscosity and contain low or zero contents of solid material. Often a low Brookfield viscosity is essential if these liquids are required to soak into wood or flow into inaccessible parts of vegetation. Attempts to use the same apparatus to spray aqueous architectural coating compositions (particularly aqueous woodstains) having a Brookfield viscosity at 22° C. of at least 0.5 (but generally not over 50 and usually 1 to 12) pa.sec and solid contents of above 7 wt % have resulted in the production of approximately cylindrical jets of small radii which impact onto no more than a tiny and approximately circular area of a target surface. The small size of this area makes the coating process very time consuming. Also for coating compositions such as clear stains having, a Krebs-Stormer viscosity of around 60 Equivalent Krebs Units (K.U) and lower even to around 40 K.U., usually at 77° F. (25° C.), the spray pattern may be of a small size and may have a dipping or spitting problem when the trigger device is released on the sprayer.

For quick coating, it is also desirable that the spraying apparatus be capable of spraying large volumes per minute of the aqueous architectural coating composition. It is preferred that a volume velocity of at least 0.2 (preferably 0.3 to 0.7) litre/minute of composition be delivered to a target surface at the preferred distance of about 300 mm otherwise the target surface can only be traversed slowly.

### SUMMARY OF THE DISCLOSURE

It has now been found possible to devise a quick process for the airless spray-coating of a surface with an aqueous-containing Newtonian or non-Newtonian architectural coating composition even when containing dispersed solid matter. Moreover, the process employs inexpensive spraying apparatus operating at pressures low enough to be used comfortably by an amateur and to be easily generated using a hand-operated compressor or electrical compressor such as a battery operated compressor. It has already been identified in the prior art that the pressure required to spray the coating composition can be generated by a powered electrical system, or using a hand pump, this choice being dependent on the pressure required and the operating environment, e.g. proximity to a power source, or the ability to recharge batteries.

Accordingly, one exemplary embodiment of this invention provides a process for the airless spray-coating of a surface with an aqueous-containing architectural coating composition. The process the airless spray-coating of a surface with the aqueous-containing architectural coating composition comprising: subjecting a composition comprising: at least one binder polymer and at least one ingredient chosen from: pigments, dyes, opacifiers and extenders which composition is suitable for coating surfaces wherein the composition contains a thickener and wherein the composition has a solids content of at least about 7 wt %, to a pressure of from 2 to 5 bar (about 30 to about 75 p.s.i.) and spraying the composition from an outlet orifice (52) in a nozzle (50) to produce an outflow (31) of the coating composition, which outflow has non-convergent boundaries (35) at least until it has formed a front of not less than least 30 mm in width. Since the process is airless, it does not include aerosols or pneumatic delivery systems but involves a reciprocating piston, pumps, or compressor acting on the composition to form a spray that carries the composition onto the surface to be coated. This process is useful for compositions which have either Newtonian and non-Newtonian flow or fluid behavior.

Another embodiment of the present invention provides a process for the airless spray-coating of a surface with a viscous aqueous non-Newtonian architectural coating composition. This process for the airless spray-coating of a surface with a viscous aqueous non-Newtonian architectural coating composition comprises subjecting an aqueous non-Newtonian architectural coating composition comprising at least one binder polymer and ingredients chosen from one or more of pigments, dyes, opacifiers and extenders which composition is suitable for coating vertical surfaces wherein the composition contains an associative thickener and has a solids content of at least 7 wt % to a pressure of from about 2 to about 5 bar; and spraying the composition from an outlet orifice (52) in a nozzle (50) to produce an essentially flat outflow (31) of the coating composition.

The another embodiment of the present invention a kit for the airless spray-coating of a surface with an aqueous containing architectural coating composition having a solids content of at least about 7 wt %, and with either Newtonian or non-Newtonian flow behaviour wherein the apparatus comprises
a) a container containing at least one binder polymer, and at least one ingredient chosen from thickeners and pigments, dyes, opacifiers and extenders,
b) a nozzle (50) in communication with the container and comprising an outlet orifice (52),
c) a compressor capable of generating a pressure of from 2 to 5 bar and
d) a pressure release valve which releases pressure from the container in the range 2 to 5 bar
   whereby generation of pressure enables composition from the container to be sprayed from the outlet orifice.

In another embodiment of the present invention the apparatus for the airless spray-coating of a surface has a viscous aqueous non-Newtonian architectural coating composition having a solids content of at least about 7 wt %, and at least one binder polymer and at least one thickener and at least one ingredient chosen from pigments, dyes, opacifiers and extenders.

For the embodiments of the present invention a suitable nozzle defines an outlet orifice in the form of a slot where the slot extends transversely of the flow of the composition through the nozzle. More specifically, the outlet orifice comprises an elongated exit having a first or “major” dimension which extends transversely of the general flow of the composition through the nozzle. The exit has a second or “minor” dimension orthogonal to the major dimension and it too extends transversely of the flow of the composition through the nozzle. In short, the major and minor dimensions define a slot transverse to the general flow of the composition through the nozzle. Preferably the minor dimension has a maximum size of 0.25 to 0.45 mm (preferably 0.3 to 0.4 mm) and the major dimension has a size of from 0.5 to 1.5 mm.

### BRIEF DESCRIPTION OF THE DRAWINGS

This invention and a preferred embodiment are illustrated with reference to drawings of which:

FIG. 1 is a diagrammatic representation of an outflow expelled from the outlet orifice when the delivery pressure is below 2.5 bar.

FIG. 2 is a diagrammatic representation of an outflow expelled from the outlet orifice when the delivery pressure is above 2.5 bar.

FIG. 3 is a diagrammatic representation of a fantail flow expelled from the exit 2 of outlet orifice when the delivery pressure is in the optimum range of 3 to 4 bar.

FIG. 4 is a diagrammatic representation of a flow expelled from the outlet orifice when the delivery, pressure is above 5 bar.

FIG. 5 is a front elevation of a nozzle according to this invention,

FIG. 6 is a section through the nozzle on line A-A in FIG. 1,

FIG. 7 is a section through the nozzle on line B-B in FIG. 1,

FIG. 8 shows on a larger scale the zone around the hemispherical end and wedge-shape shown in FIGS. 6 and 7.

FIG. 9 shows a modified outlet orifice on larger scale.

FIG. 10 shows a refinement of the invention in section and on a larger scale.

FIG. 11 shows a nozzle connected to a coupling for a deliver hose.

### DETAILED DESCRIPTION

As used herein, “water-borne coatings” have their art recognized meaning which allows for the inclusion of minor amounts of co-solvents and other volatile organic material provided water constitutes more than 50 percent, and preferably at least 80 percent of the volatile phase, so that even with the presence of minor amounts of organic solvents these coatings are still regarded as water-borne since the majority of the volatile solvent present in the liquid coating is comprised of water.

Also herein, “a”, “an”, “the”, “at least”, and the like, are used interchangeably.

All percentages, ratios and proportions herein are by weight, unless otherwise specified. All temperatures are in degrees Celsius (° C.) unless otherwise specified. Accordingly, unless indicated to the contrary, the numerical parameters set forth in the following specification and attached claims are approximations that may vary depending upon the desired properties sought to be obtained by present invention. At the very least, and not as an attempt to limit the application of the doctrine of equivalents to the scope of the claims, each numerical parameter should be construed in light of the number of significant digits and ordinary rounding approaches. Notwithstanding that the numerical ranges and parameters setting forth the broad scope of the invention are approximations, the numerical values set forth in the specific example are reported as precisely as possible. Any numerical value, however, inherently contains certain errors necessarily resulting from the standard deviation found in their respective testing measurements. As a whole, all values mentioned are indicated in conformity with the international legislation on the one hand, and in amounts pertaining to the mass on another hand. Unless otherwise stated, the proportions of the components in the compositions described are given in percentage pertaining to the total mass of the mixture of these components.

Also herein, the terms “comprised of”, “comprising”, “including”, “containing”, “having” and the like shall be read expansively and not be construed as having a limiting meaning where these terms appear in the description and claims. Of course, the inventions illustratively described herein may suitably be practiced in the absence of any element or elements, limitation or limitations, not specifically disclosed herein. Also the terms, expressions, and definitions employed herein have been used as terms of description and not of limitation, such terms, expressions and definitions are used without any intent to exclude any equivalents of the features or parts of features shown and described. It should be recognized that various modifications are possible within the scope of the invention claimed. Thus, it should be understood that although the present invention has been specifically disclosed by preferred embodiments and optional features, modification and variations of such embodiments of the invention herein disclosed adopted or applied by those skilled in the art are considered to be within the scope of this invention.

Also herein, all numbers used in the specification and claims are to be understood as being modified in all instances by the term “about”. Accordingly, unless indicated to the contrary, the numerical values used in the specification and claims may vary depending upon the desired properties which are sought to be obtained by the present disclosure.

Also herein, the term “substrate” is meant to include a range of similar or dissimilar substrates such as wood, particle board, plaster, plasterboard, gypsum board, drywall, sheetrock, and other similar materials which provides a surface on which a decorative surface coating can be applied.

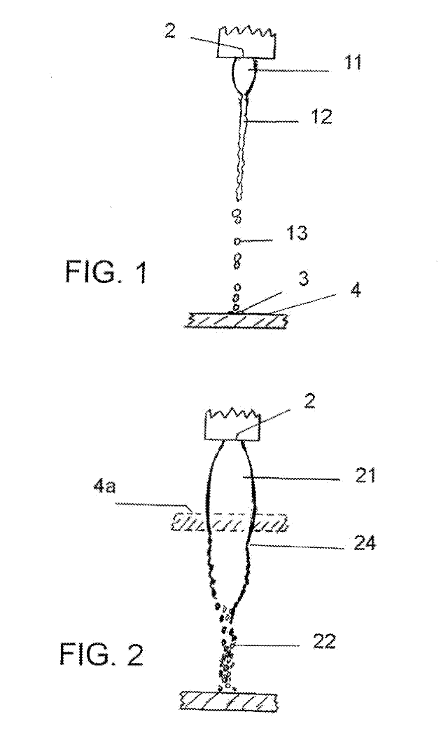

It has been discovered that when viscous aqueous non-Newtonian architectural coating compositions are delivered to the nozzle at a pressure of below 2.5 bar, the outflow of the composition from the outlet orifice is initially divergent, but its boundaries soon converge to form an approximately cylindrical jet which quickly breaks up into a stream of large drops of irregular size. When aimed at a target surface, the stream of large drops coats only a tiny area of the surface and so coating the whole surface would be a very slow process. Also, this tiny target area receives a heavy delivery of coating composition (especially, at delivery rates of 0.2 litres/minute or more) and this leads to a surfeit of composition which will dribble down a target surface if it is vertical. This sequence of events is illustrated in FIG. 1 of the drawings. The true nature of the flows associated with the spraying apparatus is not properly understood but it is supposed that at pressures below 2.5 bar, the surface tension of the composition is quite large relative to the inertial forces present in the composition as it leaves the exit from the outlet orifice and so surface tension quickly draws in the boundaries of the flow to form the approximately cylindrical jet followed by the large irregular drops.

Increasing the delivery pressure accelerates the flow through the outlet orifice and it is supposed that this brings the inertial forces more into balance with the surface tension and so produces a longer, wider and more planar, (ie flat) flow as illustrated in FIG. 2. Once again the flow has initially divergent boundaries which are subsequently caused to converge presumably by surface tension before the flow again disintegrates into large drops. The disintegration only occurs after the flow has presented the relatively planar flow having a wider front spaced at a greater and therefore more convenient distance from the outlet. This wider front can be traversed across a target surface whereupon it applies bands of coating composition of widths similar to those obtained using a typical small paint brush of say 30 mm width. Therefore it provides a usable but relatively slow coating process.

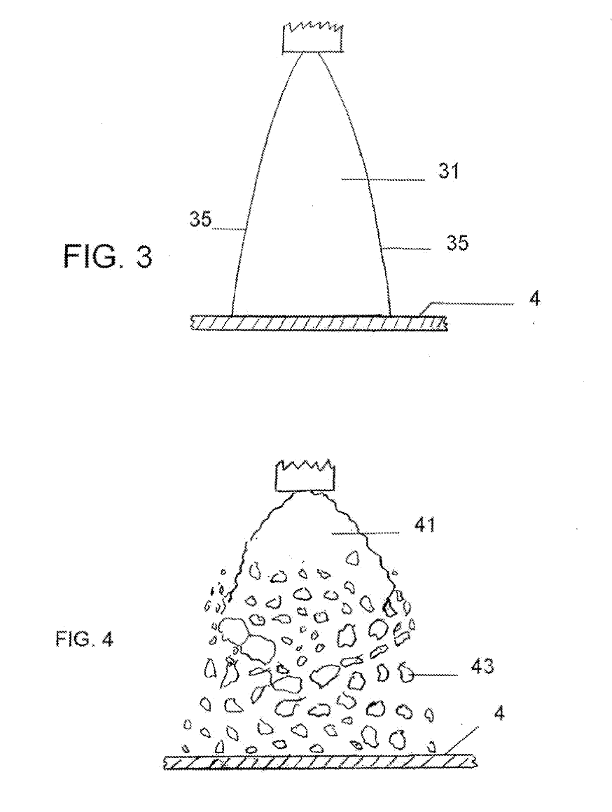

If the delivery pressure is increased to over 3 bar it is supposed that the inertial forces and surface tension come into closer balance with the result that the planar flow widens to give an approximately parabolic fantail as illustrated by FIG. 3. Using pressures above 3.5 bar, this fantail can reach widths of over 100 mm before it to breaks up into large drops. Such widths correspond to quite wide brushes, so provided the composition is being sprayed at a useful volume per minute, the composition can be applied very quickly across a target surface. As it leaves the outlet orifice, the fantail comprises a homogeneous distribution of the composition which is important for acceptably uniform coating, but it not known whether the fantail comprises an integral sheet of liquid or an atomised mist of closely spaced fine droplets or possibly a combination of both.

Finally, increasing the pressure to somewhere between 4.5 and 5 bar causes the flow to break up close to the outlet orifice. This causes the expelled composition to form very large drops very quickly as illustrated in FIG. 4. Such large drops give very inhomogeneous coatings often characterised by the appearance of streaks. It is supposed that the inertial forces now greatly exceed the ability of surface tension to control the shape of the flow. Accordingly, it would appear that there is an unexpected window of conditions between 2.5 and 5 bar which permit the spraying of viscous non-Newtonian aqueous architectural coating compositions using pressures low enough to be comfortably generated using a hand-operated compressor. The preferred range of pressures forming an optimum fantail is 3.5 to 4 5 bar, though a range of 3.2 to 3.6 bar may be better suited for use by less physically strong female amateurs. It has already been identified in the prior art that the pressure required to spray the coating composition can be generated by a powered electrical system if the manual effect required is such that a hand pump is not appropriate.

Selecting an optimum nozzle geometry is a simple matter. It is suggested that to begin, a nozzle should be chosen whose outlet exit has major and minor dimensions in about the middle of the preferred ranges, say 0.75 mm and 0.33 mm respectively and then the delivery pressure can be varied stepwise from 3.2 to 4.5 bar to investigate how the flow varies with pressure in this range. If a flow of greater width is preferred, the nozzle should be replaced by one having an outlet exit whose minor dimension is less than 0.33 mm so as to increase sheer and consequently reduce the viscosity of the composition being expelled. This increases the speed of expulsion and the width of the flow presumably because the inertial forces in the system increase with the velocity and so surface tension is more easily overcome to yield a wider flow.

Conversely, if a narrower flow is preferred for say coating narrower items such as door or window frames, the minor dimension of the outlet exit should be increased to more than 0.33 mm thereby reducing shear and retaining more of the viscosity. This decreases the speed of expulsion and the inertial forces and so presumably surface tension is better able to draw in the width of the flow.

For ease of spraying, it is preferred that the viscosities at 22° C. of the compositions should reduce to 0.015 to 0.5 pa.sec under high shear, say a shear rate of 10 000/sec as measured by an ICI Cone and Plate viscometer as described in ASTM Test D4827-88. It is also preferred that the composition should have an extensional viscosity of below 0.4 pa.sec and especially below 0.2 pa.sec when measured according to the procedure described in the Haake Caber 1 Instruction Manual available from Thermo Haake (International) of Karsruhe, Germany when using 6 mm plates having an initial separation of 3 mm.

Delivery of the composition via a plenum upstream of and leading to the outlet orifice may also be usefully employed to govern the viscosity of the composition in the region of the outlet. Preferably the plenum should have a dimension transverse the flow through the nozzle of from 0.5 to 3 (especially 1.3 to 2.7) mm and a length of 0.2 to 4 (especially 0.2 to 3) mm. Most conveniently it should be cylindrical and of about the same transverse dimension (ie. radius) as the major dimension of the outlet exit. Increasing the transverse dimensions and/or decreasing the longitudinal dimension of the plenum decreases the shear and loss of viscosity leading to a slower speed of expulsion from the outlet orifice and a narrower flow. Conversely, decreasing the transverse dimensions and/or increasing the longitudinal dimension increases the shear and the loss of viscosity leading to a faster speed of expulsion from the outlet orifice and a wider flow.

A preferred outlet nozzle geometry comprises a plenum terminating with a hemispherical end which is blind except for the outlet orifice. The orifice is preferably defined by the notional intrusion into the hemisphere of a wedge shape consisting of two opposed mutually inclined planes which meet to define a notional leading edge inside the plenum. The leading edge in effect defines the major dimension of the exit from the outlet orifice. The maximum minor dimension of the outlet exit is defined by the maximum distance between the inclined planes as they enter the hemispherical end of the plenum.

The planes are preferably inclined at into the plenum an angle of from 25° to 55° (especially 35° to 45°). Preferably, the leading edge intrudes to a point either lying on the “terminal plane” of the hemisphere or lying on a parallel plane either just upstream or just downstream of the terminal plane. The “terminal plane” of the hemisphere is the circular plane of radius equal to the radius of the sphere of which the hemisphere forms half.

Where the wedge shape penetrates no further than the terminal plane of the hemisphere, the outlet exit has a projected shape which is elliptical. If the wedge penetrates further, the projected shape is that of a curtailed ellipse whose ends are defined by the cylindrical part of the plenum and so are curtailed and have a smaller curvature than would be the case if the shape were truly elliptical. The smaller curvature is more likely to give an even coating and in particular, the coating is less likely to contain streaks. Preferably, the parallel planes should be no more than 0.8 mm upstream or downstream of the terminal plane.

The portions of the mutually inclined planes of the wedge shape which are within the hemisphere together define two opposed mutually inclined surfaces which are essentially semi-circular. This means that composition flowing in the central regions of the outlet orifice will be in closer proximity to a surface of the outlet orifice for a longer period of time than composition flowing in the lateral regions of the outlet. Composition in the central region will therefore receive more shear in the outlet orifice than composition in the lateral regions which may compensate for the fact that composition in the central region may have received less shear elsewhere. It is possible that this compensation assists-in creating a more homogenous coating of a target surface.

In order to minimise any pressure pulses which might arise from irregular hand compression, the nozzle can usefully also comprise a large chamber upstream of, and in communication with its plenum. Provided that the chamber is large relative to the plenum, its precise dimensions are not critical but for guidance, it is proposed that its transverse dimensions be about 5 to 10 times the transverse distensions of the plenum and its length be 5 to 20 (preferably 6 to 8) mm.

In a refinement of the nozzle, it is additionally provided with an auxiliary (preferably circular) orifice upstream of the plenum which receives composition under the delivery pressure of from 2.5 to 5 bar and directs it towards the plenum. The preferred transverse dimension of the auxiliary orifice is from 0.8 to 1.5 mm, its preferred length is from 1.7 to 2.3 mm and the pressure drop across the orifice is preferably from 0.5 to 2 bar. Preferably composition flows from the auxiliary orifice into a chamber of large transverse dimension as described above and then into the plenum. The use of this auxiliary orifice and large chamber can increase the width of the laminar flow expelled from the main outlet to well over 120 mm, often reaching over 400 mm. This provides an extremely quick coating process.

An unexpected advantage of the refined nozzle is its resistance to blockages. Most aqueous paints are at risk of containing a small concentration of unwanted agglomerates of pigment or opacifier particles, usually agglomerates of 200 μm or greater where μm equals 10⁻⁶ m. Agglomerates can accumulate in a nozzle and block its outlet orifice. It is supposed that the conditions of shear in the refined nozzle are sufficient to break down the agglomerates.

Other factors which might affect the balance between the inertial forces and surface tension and therefore the width and stability of the expelled flow are of course the size of the surface tension itself and the density of the composition. Both are determined by the complex formulations used to make modern architectural coating compositions and so it is not easy to vary either. In theory, surface tension can be reduced by adding detergents to a composition, but this often increases the sensitivity of the composition to water, eg. the sensitivity of a paint to rain. Hence, variation of surface tension is seldom a practical option. Most architectural paints will have a surface tension at 22° C. in the range of 23 to 45 N.10⁻³/m.

Density is strongly influenced in the architectural coating compositions by the concentration of heavy inorganic opacifiers such as rutile titanium dioxide (which also serves as a white pigment) or of coloured pigments or extenders such as chalk or clays. Pigment and extender concentrations are carefully chosen to give a colour of precise hue, chroma or lightness, so varying their concentration merely to adjust density is seldom practical. In short, density cannot be significantly varied without unacceptable consequences for opacity and colour. Generally the density of an architectural coating composition is from 1.01 to 1.6 kg/litre and is usually 1.01 to 1.2 kg/litre for woodstains and fungicides and 1.2 to 1.6 kg/litre for paints if dense pigments or opacifiers such as rutile are needed. Solid contents of the coating compositions can therefore be from 7 to 12 wt % for woodstains and fungicides and up to 70 wt % or more for paints.

Preferably the apparatus also comprises an auxiliary orifice upstream of the outlet orifice and conduit means from the auxiliary orifice to the outlet orifice so that composition can be passed through the auxiliary orifice before being sprayed from the outlet orifice.

Although this invention is primarily intended for use with hand operated compressors, if modified, it could make use of pressures generated by low pressure domestic compressors if they are able to generate pressures of 2.5 to 5 bar. It is known in the art to spray coating compositions using an electrically powered system or a manual hand pumped system, thus the use of a domestic compressor instead of the hand operated compressor is desirable since it would require less effort from the user since no manual input is required. It has also been stated earlier that the present invention employs inexpensive spraying apparatus, and therefore the type of compressors associated with low pressure domestic compressors are suitable for amateur users in that they can be used comfortably.

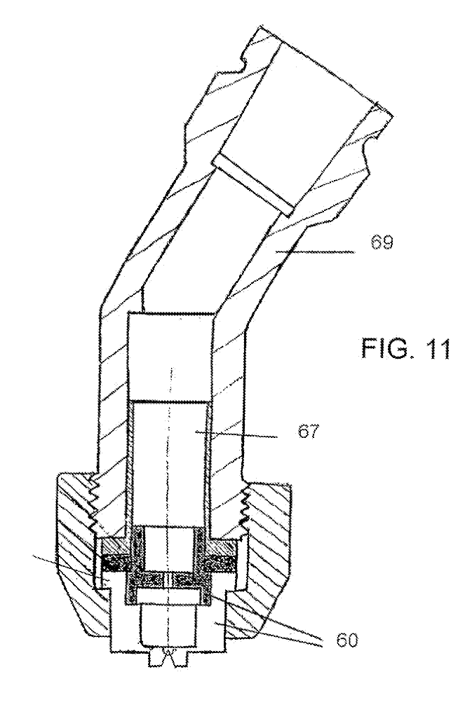

The aqueous Newtonian or non-Newtonian architectural coating composition can be contained in a tank or reservoir that has an opening usually surrounded by a neck with attachment members such as threads for the fitting of a cover over for the opening. Such an attachment member can be any of those known in the art for affixing a removable cover or cap by screwing, plugging, bayonet fitting, or any other suitable member. The cap can have a suitable sealing ring for sealing the opening in the neck of reservoir when the cap is threaded on tight. The reservoir can be of any type capable of containing a liquid product which can include liquid products comprised of a solid and a solvent the majority of which is water for progressively dissolving said solid. Also included are liquids comprising small particles in suspension. Such a reservoir can be located in a housing and can be made out of any suitable material, such as metal, alloy, glass, but is preferably made out of plastic. It comprises at least one compartment to contain at least one composition. The at least one reservoir can be fixed into the housing, and is preferably comprised of one opening, more preferably a reclosable opening. Alternatively, the at least one reservoir can be removable from the housing, so that it is replaceable when empty, or it can be refilled or rinsed for cleaning. The cover or cap also allows for passage through it of a tube so that when the cap is in place to cover the opening the tube can extent into the reservoir to contact the coating composition. In this manner the coating composition can be removed through the tube which extends into a flexible tube in fluid connection with the tube in the reservoir to convey, the coating composition to a remote spray nozzle as that shown in FIG. 11.

The housing can include two pieces of durable plastic to enclose the cover or cap or be a part of the cover or cap so as to cover the reservoir. Both sides of the two piece housing are generally symmetrical except that one side can have space to secure a power unit for location on the top of the reservoir. The two piece plastic housing is assembled and secured together generally with a number of screws or press fittings or attachment members. The housing can also be formed to provide a handle so that the power unit can be held with the user's hand. Also the housing allows for the passage of the flexible tube to carry the coating composition to the remote spray nozzle.

In one embodiment of the present invention when the coating composition is delivered by an electrically driven pump as opposed to a manual or hand operated pump, the power unit has the electrically driven pump which is used to pump the coating composition from the reservoir through the tube and the attached flexible conduit to the remote spray nozzle of FIG. 11 to the surface to be coated. In this way, the coating delivering device connected to a reservoir constitutes an electrical spraying device.

In a particularly suitable embodiment of the present invention, the device for conducting the coating composition from the reservoir through the tube and flexible conduit to the spray nozzle of FIG. 11 comprises an electrically driven pump. The electrically driven pump may be, for example, a gear pump, an impeller pump, a piston pump, a screw pump, a peristaltic pump, a diaphragm pump, or any other miniature pump. A non-exclusive example is a gear pump with a typical speed between 6000 and 12000 rpm. The pump is preferably designed so that the pressure delivered at the nozzle outlet is a pressure in the range of 2 to 5 bar.

In addition to the electrically driven pump the power unit within the housing can have space for the location of one or more batteries. This can be a battery tube which in one embodiment can hold a suitable number of batteries that may be replaced when depleted. In other embodiments, the battery tube may include a greater or lesser number of batteries such as those of sizes like D cells or such as AA sized batteries. The voltage output of the battery is typically between 1.5 and 12 Volts, with a suitable output between 3 and 12V. To allow stile replacement of the batteries, the battery tube 16 can be threadably removable from the housing for the sprayer. In another embodiment the batteries can be one or more rechargeable batteries that are permanently installed in the battery tube. Once the energy is depleted from the rechargeable battery, the battery tube can be removed from the sprayer and inserted into a charger for recharging. In some embodiments, recharging may be accomplished inductively.

The flexible conduit for conveyance of the coating composition from the reservoir to the remote spray nozzle has an intake end that starts with the tube that extends into the reservoir or is an extension of that tube and has a discharge end that is in fluid communication with the spraying nozzle like that of FIG. 11.

The pumping action on the coating composition is performed through the power unit in the housing from the electrical energy provided by the batteries to an electrical motor which through a transmission operates the pump of the power unit. The electric motor typically produces a torque between 1 and 20 mN.m. The motor can include a drive gear and the transmission can include a series of gears such as a cam and a cam follower shaft. The pump can include a piston that is linearly displaceable within a cylinder of the pump. The piston can have appropriate flanges with tips, which help clear, purge or “sweep” the cylinder. The flanges facilitate the pumping of the contents, helping to seal the cylinder by acting as O-rings. The flanges also assist in the replacement of air pressure in and return of excess liquid or fluid to the container, thereby helping to prevent both leaking and a vacuum in the reservoir. Two generally annular, circumferential flanges or any different number of flanges or flanges of a different shape, may be used. Also, the flanges may be generally flexible, particularly the tips, and/or integrally formed with the piston, or they may be separate structures, e.g., rings that are operably coupled to or carried by the piston as those skilled in the art will readily understand. Also such a gear pump or other suitable pumping mechanism may be substituted for the piston pump without departing from the spirit of the invention.

Also in one embodiment of the invention the nozzle connected to the delivery flexible conduit or hose of FIG. 11 can have a nozzle filter and check-valve arrangement to curtail continued discharge such as spitting of composition after the nozzle or the sprayer is turned off. The nozzle filter and ball-cheek valve can be in one device like those available as from Hypro Nozzles that are nozzle filters in Kemetal with stainless steel outer circumferential or peripheral screens. These screens can range from 50 to 200 mesh. Such a filter is located right behind the nozzle in the flexible delivery tube so that the coating composition is passed through the screen and into the inner annular conduit of the filter and on to the nozzle. The check valve is disposed in the path of liquid flow and is opened when the nozzle is on but is closed when the pressure is released. The valve, when closed, prevents downward flow of composition which otherwise could spit or leak from the nozzle.

Measurement of Brookfield Viscosity:

Brookfield viscosity was measured at 22° C. using a Brookfield Viscometer Model HA as supplied by Brookfield Engineering Laboratories Incorporated of Middleboro, Mass. Essentially, a Brookfield Viscometer comprises a rotateable spindle which carries a disc which, when performing the measurement, is immersed into the coating composition about 10 mm below its surface. The composition should be provided in a cylindrical container having a diameter of at least 100 mm so as to avoid errors due to the proximity of the container walls.

To perform the measurement for the purposes of this description, a Brookfield No. 3 Spindle is chosen, immersed into the composition and then rotated at Brookfield Speed No 10 for at least three revolutions. The spindle is coupled to a torque measuring device which is calibrated to express torque in terms of the viscosity of the composition either directly or after the operation of a multiplier specified by Brookfield.

Now with reference to the particular drawings embodiments of the invention with be further described.

FIG. 1 illustrates the shape of outflow 11 of composition expelled from exit 2 of an outlet orifice which shape is to be expected when the delivery pressure is less than 2.5 bar. Outflow 11 has an initially flat profile which quickly converges into an approximately cylindrical jet 12. Jet 12 is unstable and breaks up into large irregular droplets 13 before striking tiny zone 3 of target surface 4 which is spaced 650 mm from exit 2.

FIG. 2 illustrates the effects of increasing the delivery pressure beyond 2.5 bar whereupon expelled outflow 21 has an initially divergent flat profile reaching a width of about 30 mm transverse of direction the flow of composition through exit 2. Outflow 21 extends further from the exit before breaking up into large irregular droplets 22. Outflow 21 begins by diverging transversely and then coverages to a constriction 24 before becoming unstable and breaking tip into droplets 22. Because of the greater width of outflow 21, it would be possible to use it for a moderately quick coating of a target surface 4a (shown in broken lines) positioned nearer to outlet orifice 2 than surface 4 and upstream of constriction 24.

FIG. 3 illustrates the effects of increasing the delivery pressure to an optimum range of 3.5 to 4 bar. A flat outflow 31 is obtained which diverges transversely producing a shape having approximately parabolic boundaries 35 and which remains stable until it strikes target surface 4. The width of flow 31 increases to over 100 mm by the time it strikes target surface 4.

FIG. 4 illustrates the effects of a delivery pressure beyond 5 bar whereupon expelled outflow 41 still has a flat profile as it leaves outlet orifice 2 but it is unstable and it quickly disintegrates into large irregular droplets 43 long before it reaches target surface 4.

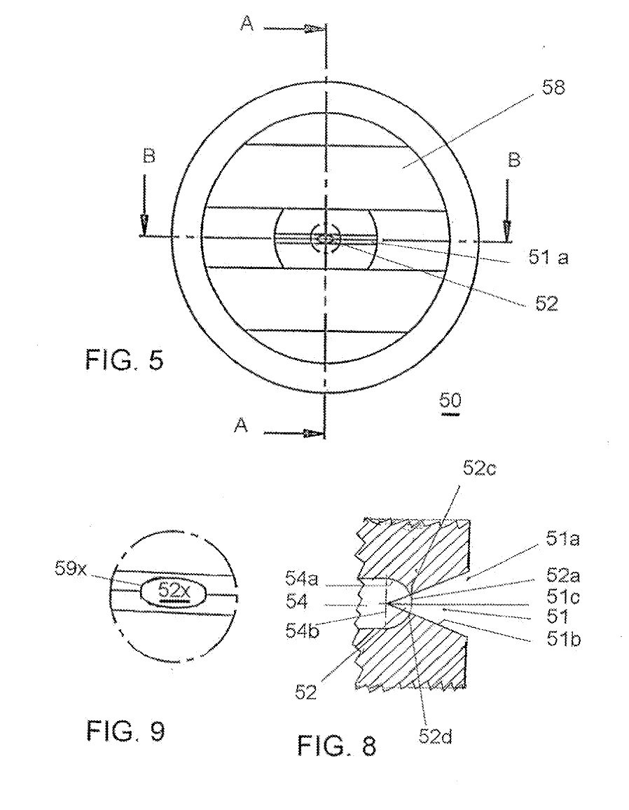

FIG. 5 shows the front elevation of a preferred nozzle 50 having opening 51a leading to wedge-shaped space 51 which (as shown in FIG. 8) is bounded by mutually inclined planes 51b. As best shown in FIG. 8, planes 51b intrude through hemispherical end 54a of plenum 54 so defining exit 52a to outlet orifice 52. The inclined planes subtend an angle of 40° and terminate in a notional leading edge 51c lying in terminal plane 54b of hemispherical end 54a. The distance as shown in FIG. 8 which extends between points 52c and 52d on inclined surfaces 52b as well as on hemispherical end 54a extends transversely of the flow of composition through nozzle 50 and defines the maximum second or minor dimension of exit 52a. Leading edge 51c extends transversely of the flow of composition through exit 52a and is also orthogonal to the second dimension of nozzle 50 and so when it is within hemispherical end 54a, leading edge 51c defines the first or major dimension of exit 52a.

Hemispherical end 54a of plenum 54 is blind except for outlet orifice 52.

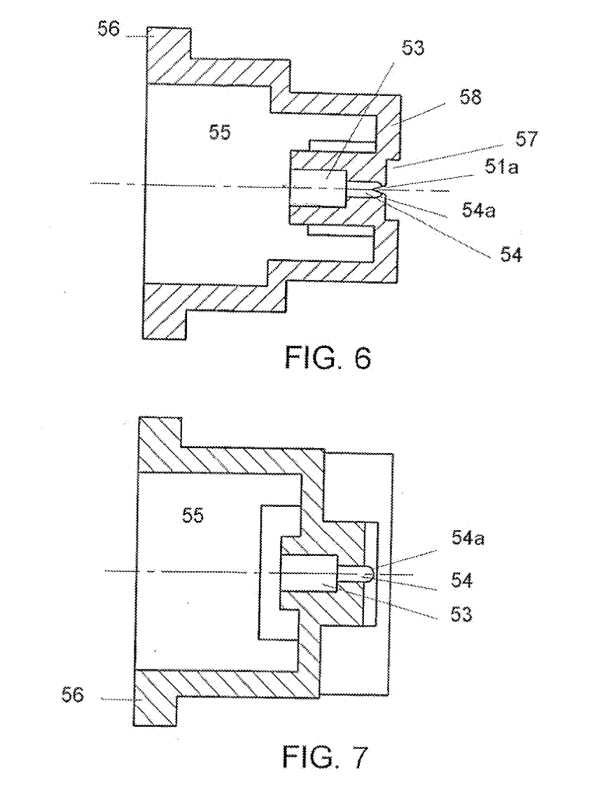

Nozzle 50 has a large chamber 53 (shown in FIGS. 6 and 7) which communicates with and is upstream of plenum 54. Large chamber 53 communicates with a connector 55 adapted to receive a hose (not shown) through which architectural coating composition under a pressure of 2.5 to 5 bar can be delivered. Large chamber 53 smoothes out any excessive pressure pulses and directs the delivered composition into plenum 54 from where it passes through outlet orifice 52 and its exit 52a to emerge as an outflow 31. Opening 51a addis exit 52a are located in a protective channel 57 defined by shoulders 58.

FIG. 9 shows on a larger scale the projection of the shape of the exit from modified outlet orifice 52x. Outlet orifice 52x is defined by a pair of mutually inclined planes which extend beyond the terminal plane of the hemisphere and into the cylindrical part of the plenum so conferring a curtailed elliptical shape on ends 59x. Ends 59x are inset from the true elliptical shape and so have a lesser curvature which serves to reduce the tendency for a coating to be streaky. The minor diameter of the curtailed elliptical shape is the minor dimension of the exit whilst its curtailed maximum diameter is the major dimension of the exit.

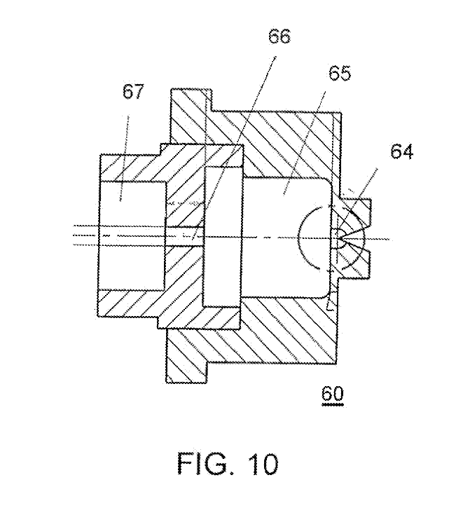

FIG. 10 shows a refinement of the embodiment shown in FIGS. 5 to 9. In FIG. 10, two part nozzle 60 has plenum 64 which is shorter than plenum 54 shown in FIGS. 6 and 7. Plenum 64 receives composition under pressure from a larger chamber 65 which in turn receives it after it has passed through auxiliary orifice 66. Larger chamber 65 and plenum 64 together serve as a conduit for conveying composition from the auxiliary orifice 66 to outlet orifice 52. Auxiliary orifice 66 reduces the tendency for blockage by agglomerates in the composition and also results in a wider fantail.

FIG. 11 shows how a nozzle such as nozzle 60 in communication with a connector 67 can be joined by a coupling 69 to a delivery hose (not shown) push-fitted over the end of coupling 69.

The nozzle may be moulded from a thermoplastics material such as polyacetal or polypropylene.

The invention is further illustrated by the following Examples.

### EXAMPLE 1

A viscous aqueous non-Newtonian woodstain was made up by mixing together the ingredients shown in Table 1. The woodstain was found to have at 22° C. a low sheer Brookfield viscosity of 2.8 to 3.0 pascal.sec, an ICI Cone and Plate viscosity of 0.02 pa.sec, a surface tension of 35 mN/m and density of 1.015 kg/litre. The woodstain was supplied in a 5 litre container into which a hand compressor capable of generating a pressure of 3 to at least 4.5 bar was fitted. It has already been stated above that electrically powered compressors can also be used to generate pressure to enable the coating composition to be sprayed. Using the compressor, woodstain was taken from the container and delivered via a hose of 10 mm diameter to a nozzle as described with reference to FIGS. 5 to 10 of the drawings and expelled from its outlet.

TABLE 1

| Ingredient | Weight % |
|---|---|
| Water | 92.7 |
| Vinyl Acetate/Vinyl “Versate” copolymer | 4.4 |
| Coloured Pigment | 2.3 |
| Cellulose/Acrylic thickeners | 0.5 |
| Biocide | 0.1 |

### EXAMPLE 2

A viscous aqueous non-Newtonian fence paint was made up by mixing together the ingredients shown in Table 2. the paint was found to have at 22° C. a low sheer Brookfield viscosity of 2.0 pa. sec, an extensional viscosity of 0.08 pa.sec, a surface tension of 35 mN/m and density of 1.027 kg/litre and a solids content of 10.1 wt %. The paint was supplied in a 5 litre container into which a hand compressor capable of generating a pressure of 3 to at least 4.5 bar was fitted. Using the compressor, paint was taken from the container and delivered via a hose of 10 mm diameter to a nozzle as described with reference to FIGS. 10 to 11 of the drawings and expelled from its outlet. The outflow was directed against a vertical surface 300 mm from the nozzle outlet which it coated with little evidence of either tramlines or dribbling.

TABLE 2

| Ingredient | Weight % |
|---|---|
| Water | 88.7 |
| Vinyl Acetate/Vinyl “Versate” copolymer | 4.4 |
| * Acrysol TT-615 Associative Thickener | 0.5 |
| Pigments | 2.9 |
| Wax Emulsion | 2.3 |
| Biocides | 0.5 |
| Coalescing solvent, ammonia and defoamer | 0.7 |

* Acrysol TT-615 is an alkali swellable acrylic polymer supplied as an associative thickener by the Rohm and Haas Company of Philadelphia.

1. A process for the airless spray-coating of a vertical surface with a viscous aqueous non-Newtonian architectural coating composition comprising a binder polymer and ingredients chosen from pigments, dyes, opacifiers and extenders which composition is suitable for coating vertical surfaces wherein
a) the composition contains a thickener and wherein the composition has a solids content of at least 7 wt %,
b) the composition is subjected to a pressure of from 2 to 5 bar and then sprayed from an outlet orifice (52) in a nozzle (50) to produce an outflow (31) of the coating composition, which outflow has non-convergent boundaries (35) at least until it has formed a front of not less than least 30 mm in width.

2. A process according to claim 1 wherein the thickener comprises an associative thickener.

3. A process for the airless spray-coating of a vertical surface with a viscous aqueous non-Newtonian architectural coating composition comprising a binder polymer and ingredients chosen from pigments, dyes, opacifiers and extenders which composition is suitable for coating vertical surfaces wherein
a) the composition contains an associative thickener and has a solids content of at least 7 wt %,
b) the composition is subjected to a pressure of from 2 to 5 bar and then sprayed from an outlet orifice (52) in a nozzle (50) to produce an essentially fat outflow (31) of the coating composition.

4. A process according to claim 3 wherein the composition is passed through an auxiliary orifice (66) upstream of the outlet orifice.

5. A process according to claim 3 wherein the composition has a Brookfield viscosity at 22° C. of at least 0.5 Pa.sec.

6. A process according to claim 3 wherein the composition is sprayed from an outlet orifice which orifice is in the form of a slot.

7. A process according to claim 6 wherein the slot is essentially elliptical or curtailed elliptical.

8. A process according to claim 6 wherein the outflow takes the shape of an approximately parabolic fantail.

9. A process according to claim 7 wherein the outflow takes the shape of an approximately parabolic fantail.

10. A process according to claim 3 wherein the pressure is generated by a hand-operated compressor.

10. A process accordingly to to claim 3 wherein the composition is passed through a plenum upstream of the outlet orifice.

11. A process according to claim 10 wherein the plenum is cylindrical terminating in a hemispherical end (54a) into which a wedge shape comprising inclined planes (51b) notionally intrudes and defines the outlet orifice.

12. Apparatus for the airless spray-coating of a surface with a viscous aqueous non-Newtonian architectural coating composition having a solids content of at least 7 wt %, wherein the apparatus comprises
a) a container containing a binder polymer, thickener and ingredients chosen from pigments, dyes, opacifiers and extenders
b) a nozzle (50) in communication with the container and comprising an outlet orifice (52),
c) a compressor capable of generating a pressure of from 2 to 5 bar and
d) a pressure release valve which releases pressure form the container in the range 2 to 5 bar
whereby generation of pressure enables composition from the container to be sprayed from the outlet orifice.

13. Apparatus according to claim 12 wherein the apparatus comprises an auxiliary orifice (66) upstream of the outlet orifice and conduit means from the auxiliary orifice to the outlet orifice so that composition can be passed through the auxiliary orifice before being sprayed from the outlet orifice.

14. Apparatus according to claim 12 wherein the outlet orifice comprises a slot (52a).

15. Apparatus according to claim 14 wherein the shape of the slot is elliptical or curtailed elliptical.

16. Apparatus according to claim 14 wherein the nozzle contains a plenum (54) upstream of the outlet orifice.

17. Apparatus according to any one of claims 12 wherein the plenum terminates in a hemispherical end (54a) into which a wedge shape comprising opposed mutually inclined planes (51b) which notionally intrude into the hemispherical end and define the shape of the outlet orifice.

18. Apparatus according to any one of claims 12 wherein the compressor is a hand-operated compressor.

19. Apparatus as claimed in claim 12 wherein the compressor is a domestic appliance able to generate a pressure of from 2 to 5 bar.

20. Apparatus as claimed in claims 12 in which the pressure generated is between 3.5 to 4.5 bar.
